(19) United States
(12) Patent Application Publication
(10) Pub. No.: US 2015/0281426 A1
(43) Pub. Date: Oct. 1, 2015

(54) SYSTEM AND METHOD FOR MANAGING VEHICLE DOOR

(71) Applicant: Hyundai Motor Company, Seoul (KR)

(72) Inventor: Chang Kiun KWARK, Seoul (KR)

(21) Appl. No.: 14/507,356

(22) Filed: Oct. 6, 2014

(30) Foreign Application Priority Data
Mar. 31, 2014 (KR) 10-2014-0037982

(51) Int. Cl. H04M 1/725; B60R 25/10; G08C 17/02

(52) U.S. Cl. CPC H04M 1/72533; G08C 17/02; B60R 25/10; G08C 2201/93

(57) ABSTRACT

A system for managing a vehicle door includes an authenticator configured to perform authentication based on information received from a smart key. A communicator is configured to receive information of a smart phone. A controller is configured to receive information on whether or not the vehicle door is opened from the authenticator and the communicator. An outputting unit is configured to manage driving history information of a driver by receiving an operation signal and the information of the smart phone from the communicator and display the driving history information on a screen.

### CROSS-REFERENCE TO RELATED APPLICATION

This application is based on and claims the benefit of priority to Korean Patent Application No. 10-2014-0037982, filed on Mar. 31, 2014 in the Korean Intellectual Property Office, the disclosure of which is incorporated herein in its entirety by reference.

### TECHNICAL FIELD

The present disclosure relates to a system for managing a vehicle and a method thereof, and more particularly, to a technology for managing a vehicle door and driving history.

### BACKGROUND

In general, with the user may control a target device with a separate wireless control apparatus and a communications module included in the target device. For example, in the case in which the control target device is a vehicle, the separate wireless control apparatus may include a key. The key and the communication module included in the vehicle may communicate with each other to lock or unlock the vehicle door. Alternatively or additionally, the key and the communication module included in the vehicle may communicate with each other to operate the vehicle (e.g., turn ON or OFF the vehicle).

To this end, in order to remotely control the target device (e.g., the vehicle), the user may have to carry the wireless control apparatus (e.g., the key), a task that may be burdensome for the user.

This task may be even more burdensome for the user if he or she has to also carry other items such as, for example, the user's mobile phone. In view of the foregoing, there is a need for a system that allows the user to use his or her Bluetooth enabled mobile phone instead or in addition to the wireless control apparatus (e.g., the key) to remotely control the target device (e.g., the vehicle).

However, because the Bluetooth enabled mobile vehicle remote control apparatus using Bluetooth is vulnerable to security, it may be problem when the vehicle is stolen. Further, in the case in which the vehicle door is opened by simply using a smart key, it is difficult to identify a driver.

### SUMMARY

The present disclosure has been made to solve the above-mentioned problems occurring in the prior art while advantages achieved by the prior art are maintained intact.

An aspect of the present disclosure provides a system for managing a vehicle door and a method thereof capable of automatically controlling the vehicle door by using a smart phone and a smart key, enhancing security by authentication from the smart phone and the smart key, respectively, and managing driving history according to a driver by the number of the smart phone which is pre-registered.

According to an exemplary embodiment of the present disclosure, a system for managing a vehicle door includes an authenticator configured to perform authentication based on security information received from a smart key. A communicator is configured to receive information of a smart phone. A controller is configured to receive information on whether or not the vehicle door is opened from the authenticator and the communicator. An outputting unit is configured to manage driving history information of a driver by receiving an operation signal and the information of the smart phone from the communicator and to display the driving history information on a screen.

The communicator and the smart phone may cooperatively operate by using Bluetooth, and initial screen touch or encryption screen information of the smart phone may be transmitted to the communicator.

The authenticator and the communicator may simultaneously transmit the information on whether or not the vehicle door is opened to the controller.

The communicator may transmit the operation signal to the outputting unit while simultaneously transmitting the information on whether or not the vehicle door is opened to the controller.

The controller may transmit the driving history information to the outputting unit while simultaneously controlling whether or not the vehicle door is opened.

The outputting unit may have the driving history information according to the driver stored therein before driving a vehicle.

The driving history information may include a mileage, a driving date, driving costs, and a driving destination.

According to another exemplary embodiment of the present disclosure, a method for managing a vehicle door includes performing authentication based on information received from a smart key by an authenticator. Information of a smart phone is received by a communicator. Information on whether or not the vehicle door is opened is received from the authenticator and the communicator by a controller. Driving history information of a driver is managed by receiving an operation signal and the information of the smart phone from the communicator, and the driving history information is displayed on a screen by an outputting unit.

The communicator and the smart phone may cooperatively operate by using Bluetooth and initial screen touch or encryption screen information of the smart phone may be transmitted to the communicator.

The authenticator and the communicator may simultaneously transmit the information on whether or not the vehicle door is opened to the controller.

The communicator may transmit the operation signal to the outputting unit while simultaneously transmitting the information on whether or not the vehicle door is opened to the controller.

The controller may transmit the driving history information to the outputting unit while simultaneously controlling whether or not the vehicle door is opened.

The outputting unit may have the driving history information according to the driver stored therein before driving a vehicle.

The driving history information may include a mileage, a driving date, driving costs, and a driving destination.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram describing a system for managing a vehicle door according to an exemplary embodiment of the present disclosure.

FIG. 2 is a flowchart describing an operation method of a system for managing a vehicle door according to an exemplary embodiment of the present disclosure.

### DETAILED DESCRIPTION

Hereinafter, exemplary implementations of the present disclosure will be described in detail with reference to the accompanying drawings. The disclosure may, however, be exemplified in many different forms and should not be construed as being limited to the specific implementations set forth herein. Rather, these implementations are provided so that this disclosure will be thorough and complete, and will fully convey the scope of the disclosure to those skilled in the art.

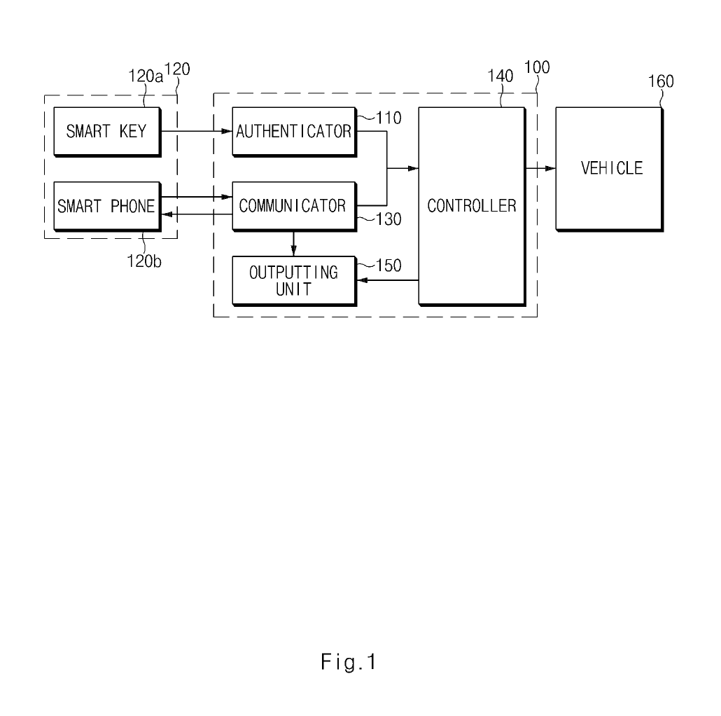

FIG. 1 is a configuration diagram describing a system for managing a vehicle door according to an exemplary embodiment of the present disclosure.

Referring to FIG. 1, a system 100 for managing a vehicle door includes an authenticator 110 configured to perform security authentication based on security information received from a smart key 120a of a driver outside a vehicle 160. A communicator 130 is configured to receive execution information of a smart phone 120b. A controller 140 is configured to receive information on whether or not the vehicle door is opened from the authenticator 110 and the communicator 130. An outputting unit 150 is configured to managing and displaying driving history information of the vehicle 160 according to the driver by receiving an operation signal from the communicator 130 and receiving information on the smart phone 120b from the communicator 130. Here, the smart key 120a and the smart phone 120b may be referred to as a smart device 120.

The authenticator 110 performs the security authentication by simultaneously operating with the smart key 120a. That is, the authenticator 110 receives authentication encryption information from the smart key 120a and transmits a door opening signal to the controller 140. The authenticator 110 may be referred to as a smart-key unit.

The communicator 130 may receive various information including information which is stored in the smart phone 120b (e.g., phone numbers, names, application data information, and the like stored in the smart phone), opening information of an initial screen, or the like. Here, the received information may also include the authentication encryption information similar to that in the authenticator 110. Further, the communicator 130 is automatically cooperatively operated with the smart phone 120b by Bluetooth. The communicator 130 receives a variety of information including the information which is stored in the smart phone 120b, the opening information of the initial screen, and the like, and then transmits the door opening signal to the controller 140.

In addition, the communicator 130 enables the outputting unit 150 to be operated by transmitting the operation signal to the outputting unit 150 while simultaneously transmitting the door opening signal to the controller 140.

When the driver carrying the smart key 120a and the smart phone 120b approaches the vehicle, the authenticator 110 executes the security authentication by cooperatively operating with the smart key 120a, and the communicator 130 is automatically operated with the smart phone 120b by Bluetooth. If the driver touches the smart phone 120b or inputs encryption to an encryption screen in a cooperatively operated situation described above, the smart phone 120b transmits door opening execution information and various information of the smart phone 120b to the communicator 130.

The controller 140 controls the door opening by receiving information on whether or not the vehicle door is opened from the authenticator 110 and the communicator 130.

Specifically, the controller 140 is a body control module (BCM) and serves to control whether or not the door of the vehicle is opened. That is, in the case in which the authenticator 110 transmits the door opening signal to the controller 140, but the communicator 130 does not transmit the door opening signal or the information of the smart phone 120b, the controller 140 controls the door of the vehicle so that the door of the vehicle is not opened. On the contrary, in the case in which the communicator 130 transmits the door opening signal or the information of the smart phone 120b, but the authenticator 110 does not transmit the door opening signal to the controller 140, the controller 140 controls the door of the vehicle so that the door of the vehicle is not opened.

The outputting unit 150 receives the operation signal and the information of the smart phone 120b from the communicator 130. That is, the outputting unit 150 may manage driving history information by matching the phone number among the information of the smart phone received from the communicator 130 with the driver.

The outputting unit 150 may store and update the driving history information of the driver therein and output the driving history information of the driver to display it on a screen. The outputting unit 150 may be a display apparatus including navigation. Here, the driving history information of the driver may include a driving date, a mileage, driving costs, and a driving destination.

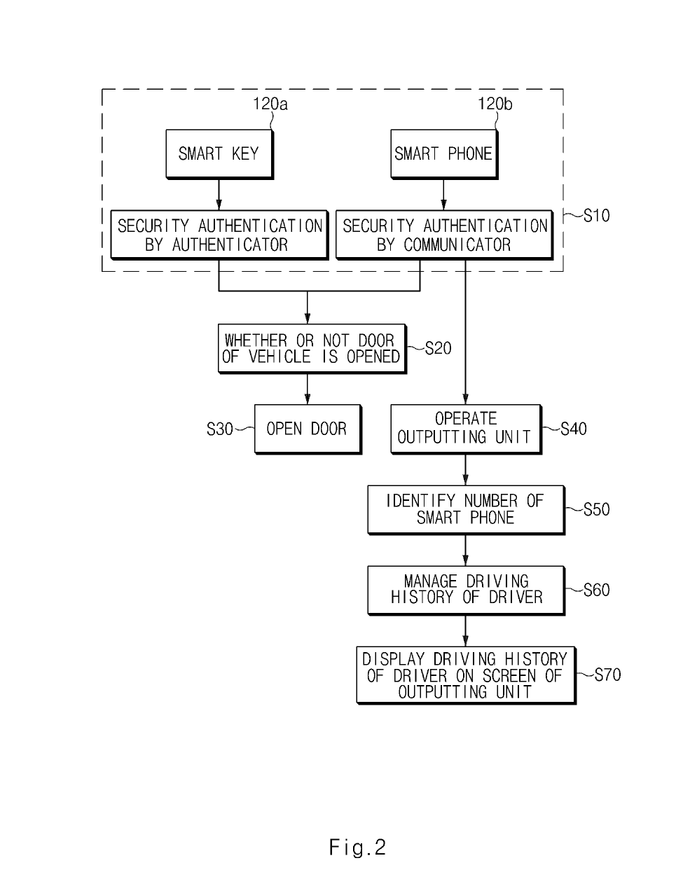

FIG. 2 is a flowchart describing an operation method of a system for managing a vehicle door according to an exemplary embodiment of the present disclosure.

Referring to FIG. 2, the authenticator 110 performs the security authentication based on the security information received from the smart key 120a of the driver outside a vehicle, and at the same time, the communicator 130 receives the information of the smart phone 120b while the authenticator 110 performs the security authentication (S10). Here, in the case in which the smart key 120a is in the vehicle when the authenticator 110 performs the security authentication, the door is not automatically opened.

Here, the authenticator 110 performs the security authentication by cooperatively operating with the smart key 120a. The authenticator 110 receives the authentication encryption information of the smart key and transmits the door opening signal to the controller 140. The authenticator may be referred to as a smart-key unit.

Further, the communicator 130 may cooperatively operate with the smart phone 120b to receive a variety of information including information stored in the smart phone 120b, opening information of an initial screen, and the like. The communicator 130 automatically, cooperatively operate with the smart phone 120b by Bluetooth, and receives a variety of information including the information stored in the smart phone 120b, the opening information of the initial screen, and the like, and then transmits the door opening signal to the controller 140. At the same time, the communicator 130 enables the outputting unit to be operated by transmitting the operation signal to the outputting unit 150.

Next, the controller 140 receives the information on whether or not the door of the vehicle is opened from the authenticator 110 and the communicator 130, and if the received information on the door opening is normal, the controller 140 opens the door (S20 and S30).

The controller 140 controls the door opening by receiving the information on whether or not the door of the vehicle is opened from the authenticator 110 and the communicator 130.

That is, the controller 140 is a body control module (BCM) and finally determines whether or not the door of the vehicle is opened. In the case in which the authenticator 110 transmits the door opening signal to the controller 140, but the communicator 130 does not transmit the door opening signal and the information of the smart phone 120b, the controller 140 controls the door of the vehicle so that the door of the vehicle is not opened. On the contrary, in the case in which the communicator 130 transmits the door opening signal and the information of the smart phone 120b, but the authenticator 110 does not transmit the door opening signal to the controller 140, the controller 140 controls the door of the vehicle so that the door of the vehicle is not opened.

Next, the outputting unit 150 operates by receiving the operation signal from the communicator 130 (S40).

The outputting unit 150 receives the operation signal and the information of the smart phone 120b from the communicator 130. In addition, the outputting unit may manage the driving history information by matching the phone number among the information of the smart phone received from the communicator with the driver (S50 and S60). The outputting unit 150 may store and update the driving history information of the driver therein and output the driving history information of the driver to thereby display it on a screen (S70). The outputting unit 150 may include a display apparatus including navigation. Here, the driving history information of the driver may include a mileage, a driving date, driving costs, and a driving destination.

According to the exemplary embodiment of the present disclosure, the driver may automatically control the vehicle door by using the smart phone and the smart key, the security may be enhanced by the authentication from the smart phone and the smart key, respectively. The identification of the driver may be secured upon occurring a vehicle accident or a vehicle problem by managing the driving history according to the driver by a pre-registered number of the smart phone.

Although the present disclosure has been described with reference to exemplary embodiments and the accompanying drawings, it would be appreciated by those skilled in the art that the scope of the present disclosure is not limited thereto but various modifications and alterations might be made without departing from the scope defined in the claims and their equivalents.

What is claimed is:

1. A system for managing a vehicle door, comprising:
an authenticator configured to perform authentication based on information received from a smart key;
a communicator configured to receive information of a smart phone;
a controller configured to receive information on whether or not the vehicle door is opened from the authenticator and the communicator; and
an outputting unit configured to manage driving history information of a driver by receiving an operation signal and the information of the smart phone from the communicator, and the outputting unit displaying the driving history information on a screen.

2. The system for managing the vehicle door according to claim 1, wherein the communicator and the smart phone are configured to cooperatively operate by using Bluetooth, and initial screen touch or encryption screen information of the smart phone is transmitted to the communicator.

3. The system for managing the vehicle door according to claim 1, wherein the authenticator and the communicator are configured to simultaneously transmit the information on whether or not the vehicle door is opened to the controller.

4. The system for managing the vehicle door according to claim 1, wherein the communicator is configured to transmit the operation signal to the outputting unit while simultaneously transmitting the information on whether or not the vehicle door is opened to the controller.

5. The system for managing the vehicle door according to claim 1, wherein the controller is configured to transmit the driving history information to the outputting unit while simultaneously controlling whether or not the vehicle door is opened.

6. The system for managing the vehicle door according to claim 1, wherein the outputting unit is configured to store the driving history information according to the driver stored therein before driving a vehicle.

7. The system for managing the vehicle door according to claim 1, wherein the driving history information includes a mileage, a driving date, driving costs, and a driving destination.

8. A method for managing a vehicle door comprising steps of:
performing, by an authenticator, authentication based on security information received from a smart key;
receiving, by a communicator, information of a smart phone;
receiving, by a controller, information on whether or not the vehicle door is opened from the authenticator and the communicator; and
managing, by an outputting unit, driving history information of a driver by receiving an operation signal and the information of the smart phone from the communicator, and displaying the driving history information on a screen.

9. The method for managing the vehicle door according to claim 8, wherein the communicator and the smart phone cooperatively operate by using Bluetooth, and initial screen touch or encryption screen information of the smart phone is transmitted to the communicator.

10. The method for managing the vehicle door according to claim 8, wherein the authenticator and the communicator simultaneously transmit the information on whether or not the vehicle door is opened to the controller.

11. The method for managing the vehicle door according to claim 8, wherein the communicator transmits the operation signal to the outputting unit while simultaneously transmitting the information on whether or not the vehicle door is opened to the controller.

12. The method for managing the vehicle door according to claim 8, wherein the controller transmits the driving history information to the outputting unit while simultaneously controlling whether or not the vehicle door is opened.

13. The method for managing the vehicle door according to claim 8, wherein the outputting unit stores the driving history information according to the driver stored therein before driving a vehicle.

14. The method for managing the vehicle door according to claim 8, wherein the driving history information includes a mileage, a driving date, driving costs, and a driving destination.

15. A non-transitory computer-readable recording medium comprising computer executable instructions of which cause a processor to perform the method according to claim 8.
